(19) United States
(12) Patent Application Publication
(10) Pub. No.: US 2006/0284128 A1
(43) Pub. Date: Dec. 21, 2006

(54) Spherical surface push-in sealing method and a sealing valve utilizing the method

(76) Inventor: Yongbin Dong, Quzhou City (CN)

Correspondence Address: JACOBSON HOLMAN PLLC, 400 SEVENTH STREET N.W., SUITE 600, WASHINGTON, DC, 20004, US

(21) Appl. No.: 11/272,801

(22) Filed: Nov. 15, 2005

(30) Foreign Application Priority Data
Jun. 19, 2005 (CN) 200510078464.5

(51) Int. Cl. F16K 31/44

(52) U.S. Cl. 251/83

(57) ABSTRACT

The invention provides a spherical surface push-in sealing method using a valve core with a spherical surface to engage a seal base, wherein an initial position is arranged for the valve core, so that the valve core is retained in the initial position before use. When in use, the valve core is pushed out of the initial position by a forward axial force. The valve core moves axially in the valve chamber under the action of the axial forces to close and open the seal. The invention also provides a sealing valve using the sealing method comprising a valve body, a valve core, a seal base. The engaging surface of the valve core and the seal base being a spherical surface, wherein an elastic stand for the valve core is arranged in the valve body and opposite to the initial position for the valve core, a rod is arranged behind the valve core, and an opening is arranged on the valve chamber to communicate with the outside. The pre-tightening force of the seal surface of the invention can be regulated according to different needs. The seal is reliable and constant, and can be used for both the non-refillable sealing valve and the refillable sealing valve.

### BACKGROUND OF THE INVENTION

1. Field of the Invention

The invention relates to a method for sealing pressure containers and the technology of sealing valves, particularly the fastening seals, pressure container seals and valve seals.

2. Description of the Related Art

Presently, most of the known spherical sealing methods utilize either fastening or rotating elements. The fastening sealing method employs a fastening member to press a spherical object with a seal base. The spherical object and the seal base cannot move relative to each other during use. Therefore, the fastening sealing method only has a sealing function. On the other hand, in the rotating sealing method, the spherical object can be moved during use, and the functions of closing and opening the seal surface can be achieved by using channels or spherical surfaces on the spherical object. However, the pretightening force of the seal surface will decrease with the increase of the opening and closing times. Thus, the sealing effect will decline and leakage may finally occur.

### SUMMARY OF THE INVENTION

The present invention provides a spherical surface push-in sealing method. According to the method, it is possible to close and open the spherical seal, and simultaneously retain appropriate pretightening force of the seal surface. To achieve this goal, a valve core is provided with a spherical surface to engage a seal base, wherein an initial position is arranged for the valve core so that the valve core is retained in the initial position before use. While in use, the valve core is pushed out of the initial position by a forward axial force. The valve core moves axially in the valve chamber under the action of the axial forces to close and open the seal. By adopting this method, the pretightening force of the seal surface can be regulated according to different needs, thus, the seal is reliable. In addition, there is no friction between the seal surfaces and the seal surface is not subject to wearing, so the sealing effect is constant. Furthermore, compared with the conventional seal methods, the sealing method provided by the present invention can be used more broadly. It can be used not only for a non-refillable sealing valve but also for a refillable sealing valve.

The axial forces may comprise a forward push force exerted from behind the valve core and acting on the valve core, and a backward push force generated by the medium pressure difference between the front end and the rear end of the valve core. The axial forces also comprise a backward push force by a spring arranged between the valve core front end and the seal base to act on the valve core.

In addition, a plurality of sealing valves using the sealing method can be used in parallel to seal multiple independent openings.

The present invention is also aimed to provide a sealing valve using the aforementioned sealing method. To achieve this purpose, the sealing valve is provided with a valve body, a valve core, a seal base, wherein the commensurate fitting surfaces of the valve core and the seal base are spherical surfaces, an elastic stand for the valve core is arranged in the valve body and corresponding to an initial position for the valve core, a rod is arranged behind the valve core, and an opening is arranged on the valve chamber to communicate with outside. By adopting this structure, the sealing valve provided by the present invention has a simple structure, and the spherical seal can be closed and opened. Furthermore, the pretightening force of the seal surface can be regulated according to different needs, and the sealing property is reliable and constant. The sealing valve provided by the present invention can be used not only as a non-refillable sealing valve, but also as a refillable sealing valve after arranging a spring between the valve core and the seal base.

### BRIEF DESCRIPTION OF THE DRAWINGS

FIG. 1 is a sectional view of the first embodiment of present the invention wherein the valve core is in its initial position.

FIG. 2 is a sectional view of the first embodiment of the present invention in a sealing state.

FIG. 3 is a sectional view of the first embodiment of the present invention wherein the sealing state is released.

FIG. 4 is a sectional view of the first embodiment of the present invention, wherein refilling the medium is prevented.

FIG. 5 is a sectional view of the sealing valve using the method of the first embodiment of the present invention installed in a valve body.

FIG. 6 is a sectional view of the second embodiment of the present invention wherein the valve core is in its initial position.

FIG. 7 is a sectional view of the second embodiment of the present invention in the sealing state.

FIG. 8 is a sectional view of a valve being gradually opened according to the second embodiment of the present invention when the rod moves backward.

FIG. 9 is a sectional view of second embodiment of the present invention that allows refilling the medium.

FIG. 10 is a sectional view of the sealing valve using the method in the second embodiment of the present invention installed in a valve body.

FIG. 11 is a sectional view of the sealing method in the first embodiment when used for sealing control of a plurality of independent spaces.

FIG. 12 is a sectional view of the second embodiment of the present invention when used for sealing control of a plurality of independent spaces.

### DETAILED DESCRIPTION OF THE EMBODIMENTS

### The First Embodiment

Referring to FIG. 1, the valve core 7 of the present invention is provided with a spherical surface to fit the seal base 9, wherein an initial position 71 for the valve core 7 is located, so that the valve core 7 is retained in the initial position 71 before use. While in use, the valve core 7 is pushed out of the initial position 71 by a forward axial force, so that the valve core moves axially in a valve chamber under the action of the axial forces to close and open the seal opening.

In this embodiment, the direction from the valve core 7 to the seal base 9 is defined as the forward direction, and the opposite direction is defined as the backward direction. Accordingly, the front end and the rear end of the valve core 7 can be distinguished. In addition, the forward movement and backward movement of the valve core 7 are the axial movements of the valve, and the forces acting on the valve core 7 in this direction are the axial forces acting on the valve core 7.

The valve core 7 preferably includes a spherical object, or a part with a spherical surface facing the seal base 9 such as a top/gyrostat-shaped part with a spherical bottom.

FIG. 1 shows the valve being used for the first time. There is an elastic stand 6 retaining the valve core 7 in the initial position 71 before use. Preferably, the stand 6 can be made as a single part arranged above the seal base in the valve body. The stand 6 may comprise a ring-shaped installation mainbody 61, and a plurality of elastic pawls 62 being arranged under the installation mainbody 61 to clamp the valve core 7 into the initial position 71. The stand 6 can also be composed of other parts such as an elastic collar with an extendable and retractable inner diameter. The function of the stand 6 is as follows: when the valve core is in the stand, the valve core 7 can be retained in the stand 6; when the forward axial force reaches a certain value, the valve core 7 can be detached from the stand 6 and engage the seal base 9.

In FIG. 1, there is a rod 2 arranged behind the valve core 7 and connected with screw threads in the valve body 11 as shown in FIG. 5. When the rod 2 is continuously screwed into the valve body, a forward push force is exerted onto the valve core 7. There is also a nut 3 arranged on the valve body. A guide block 4 for guiding the rod movement is located under the nut 3. A sealing ring 5 is located between the guide block 4 and the installation mainbody 61.

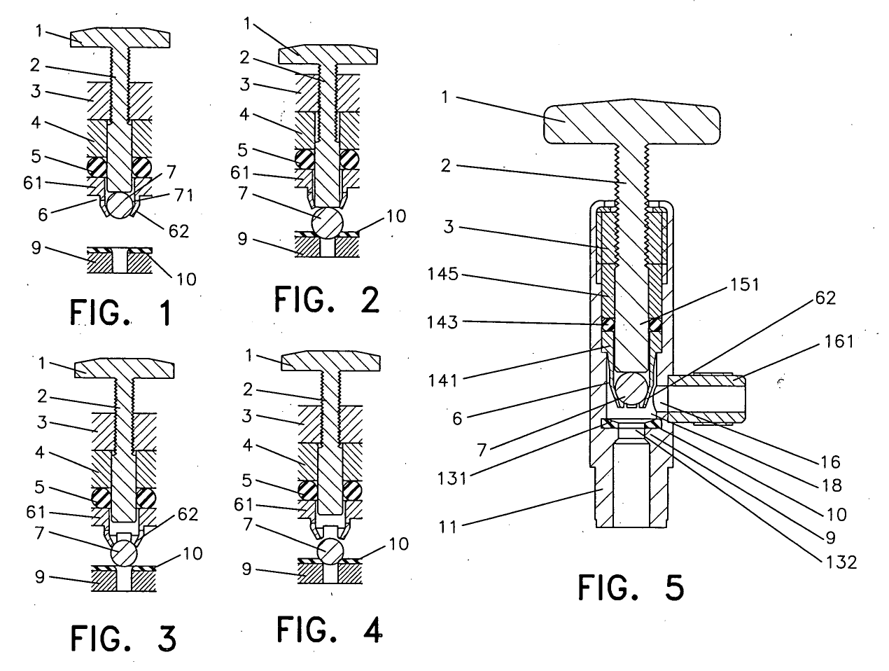

Referring to FIG. 2, when the handle 1 of the rod 2 is forced to rotate clockwise, the rod 2 moves forward and pushes the valve core 7 out of the stand 6 to engage the seal base 9. Compared with the conventional sealing methods, the sealing method provided by the present invention can regulate the pretightening force between the valve core 7 and the seal base 9 by adjusting the rod 2 according to different practical requirements. An elastic seal pad 10 can be used to improve the sealing property.

In FIG. 1, it is possible to fill a medium into the seal-controlled container. When the filling is finished, the container can be closed as shown in FIG. 2. Referring to FIG. 3, if a release operation is needed, the handle 1 of the rod 2 is forced to rotate anticlockwise, the rod 2 is moved backward, thus, the forward push force on the valve core 7 exerted by the rod 2 is removed. The backward push force generated by the medium pressure difference between the front end and the rear end of the valve core 7 pushes the valve core 7 out of the seal base 9, then the medium is released and discharged from the opening of the valve chamber.

The sealing method provided by the present invention can also be used for the non-refillable sealing valve. Referring to FIG. 4, a second filling into the container is attempted, because the valve core 7 is not retained in the stand 6, the forward push force generated by the medium pressure difference between the front end and the rear end of the valve core 7 pushes the valve core 7 to press onto the seal base 9, thus preventing a second filling.

Referring to FIG. 5, the structure of the sealing valve used in the aforementioned method is shown. The sealing valve is provided with a valve body 11, a valve core 7, a seal base 9, wherein the fitting surface of the valve core 7 and the seal base 9 is a spherical surface, an elastic stand 6 for the valve core 7 is arranged in the valve body 11 and corresponding to the initial position for the valve core 7, a rod 2 is arranged behind the valve core 7, and an opening 16 is arranged on the valve chamber 18 to communicate with the outside.

A hole mouth 132 of the seal base 9 fitting the valve core 7 can be an arced surface, a conical surface, or a cylindrical surface. In order to achieve better sealing properties, the hole mouth 132 is preferably cylindrical, because when a line contact is used to seal the valve core 7 and the hole mouth 132, a maximum sealing pressure can be achieved, and the sealing is more reliable. In order to achieve better sealing reliability, processing feasibility and opening property of the valve, the hole mouth 132 of the seal base 9 engaging the valve core 7 is preferably an arced surface.

The hole mouth 132 of the seal base 9 can be equipped with an elastic sealing pad 10.

In FIG. 5, the elastic stand 6 comprises a ring-shaped installation mainbody 141 positioned onto the valve body inner wall by means of a step fit. A plurality of elastic pawls 62 are arranged under the installation mainbody 141. There is an O-shaped sealing ring 143 around the smooth section 151 of the rod 2. The rod 2 can be directly connected with the screw thread of the valve, and move forward or backward through the rotation of the handle 1. Alternatively, the rod 2 can be connected with the screw threads of a nut 3 as shown in FIG. 5, then the nut 3 can be connected with the screw threads of the valve. A pressing ring 145 is positioned between the nut 3 and the installation main body 141. The pressing ring 145 can guide the movement of the rod 2. At the same time, by changing the length of the pressing ring 145, the corresponding position of the nut 3 on the valve body can be regulated, and the rod stroke can be conveniently changed so as to meet different requirements for the sealing valve under different conditions. A connection nozzle 161 with screw threads is arranged on an opening 16 to communicate with outside pipes.

### The Second Embodiment

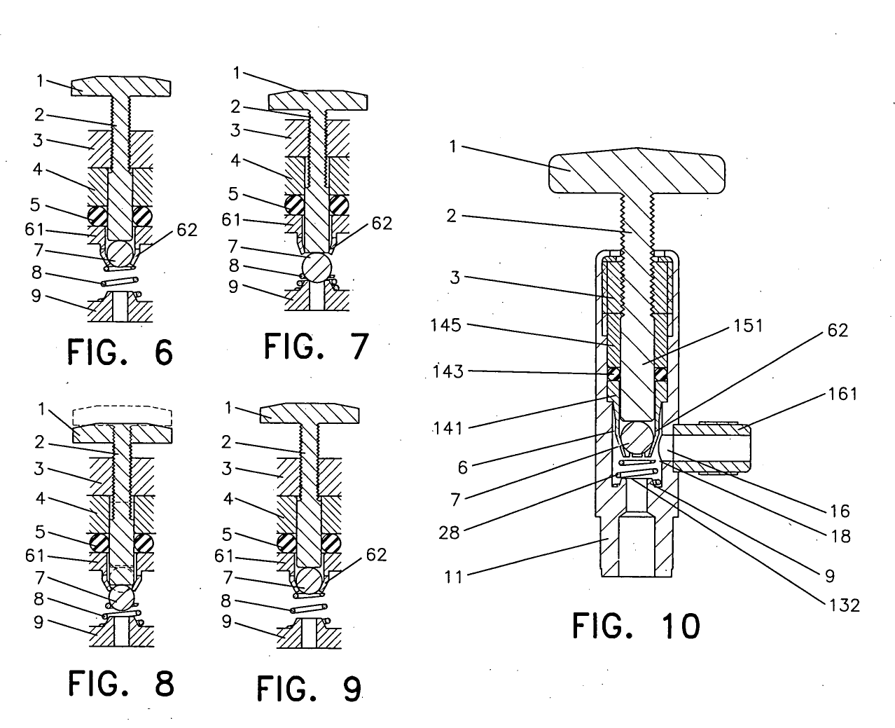

In this embodiment, a spring is added between the valve core and the seal base on the basis of the method provided by the first embodiment. In FIG. 6 to FIG. 9, the reference numerals are the same as those of FIG. 1 to FIG. 4 to represent the same parts.

This embodiment demonstrates the sealing method provided by the present invention when used for re-filling situations. FIG. 6 is a schematic drawing of this embodiment when the valve core is in the initial position. In FIG. 7, the rod moves forward and pushes the valve core onto the seal base to place the valve in the sealing state. In FIG. 8, the rod moves backward, and the forward push force on the valve core exerted by the rod is removed, the valve core is gradually pushed up by a spring 8. If the medium pressure difference between the front end and the rear end of the valve core still exists, a push force acting on the valve core in the same direction as the spring 8 will be generated.

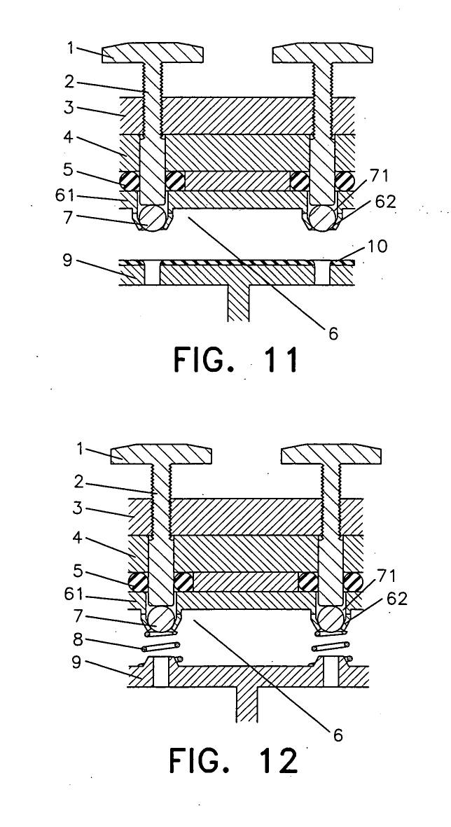

FIG. 9 demonstrates in a schematic drawing of the second embodiment of the present invention when refilling medium into the container. In FIG. 9, the valve core has already been pushed into the stand by the backward axial force generated by the spring 8 and the medium pressure difference. Because the valve core is retained in the stand when filling the medium, the forward push force generated by the medium pressure difference between the front end and the rear end of the valve core will not push the valve core out of the stand, thus a second filling is achieved.

Referring to FIG. 10, the structure of the sealing valve used in the method of the second embodiment is shown. A spring 8 is added between the valve core and the seal base on the basis of the sealing valve demonstrated in FIG. 5. In FIG. 10, the reference numerals are the same as those in FIG. 5 to represent the same parts.

Referring to FIG. 11, the seal control method in the first embodiment when used for sealing a plurality of independent spaces is shown. In FIG. 10, the reference numerals are the same as those in FIG. 1 to FIG. 4 to represent the same parts.

Referring to FIG. 12, the seal control method in the first embodiment when used for sealing a plurality of independent spaces is shown. In FIG. 12, the reference numerals are the same as those in FIG. 6 to FIG. 9 to represent the same parts.

1. A spherical surface push-in sealing method utilizing a valve core with a spherical surface to engage an opening of a seal base, comprising the steps of:
providing an initial position for the valve core, so that the valve core is retained in the initial position before sealing;
pushing the valve core out of the initial position by a forward axial force, so that the valve core moves axially in a valve chamber under the action of the axial forces to close and open the opening.

2. The spherical surface push-in sealing method according to claim 1, wherein said axial forces comprise a forward push force exerted from behind the valve core and acting on the valve core, and a backward push force generated by a medium pressure difference between a front end and a rear end of the valve core.

3. The spherical surface push-in sealing method according to claim 2, wherein said axial forces also comprise a backward push force exerted by a spring arranged between the valve core front end and the seal base and acting on the valve core.

4. The spherical surface push-in sealing method according to claim 3, wherein when the forward push force exerted from behind the valve core and acting on the valve core is removed, said spring can push the valve core back to the initial position.

5. The spherical surface push-in sealing method according to claim 1, wherein a plurality of sealing valves are used in parallel to seal a plurality of openings, respectively.

6. A sealing valve comprises a valve body containing a valve core and a seal base therein, the valve core engaging a portion of the seal base to seal an opening therein, the engaging surface of the valve core being a spherical surface, wherein an elastic stand is arranged in the valve body to hold the valve core at an initial position spaced from and above the opening of the seal base, a rod is arranged behind the valve core and opposite to the seal base, and a valve opening is arranged on a valve chamber between the rod and the seal base to communicate with the outside of the valve body.

7. The sealing valve according to claim 6, wherein a spring is arranged between the valve core and the seal base.

8. The sealing valve according to claim 6, wherein the portion of the seal base engaging the valve core is selected from the group consisting of an arced surface, a conical surface, or a cylindrical surface.

9. The sealing valve according to claim 6, wherein the seal opening of the seal base is surrounded with an elastic seal pad.

10. The sealing valve according to claim 6, wherein said valve body is provided with a nut therein connected with screw threads in the valve body at a position above the elastic stand, a press ring and a seal ring are arranged between the elastic stand and the nut, the rod having a screw-thread section connected with the screw threads of the nut and a smooth section engaging the sealing ring.
